(19) United States
(12) Patent Application Publication
(10) Pub. No.: US 2015/0051916 A1
(43) Pub. Date: Feb. 19, 2015

(54) METHOD AND A SYSTEM TO DETERMINE AND INDICATE THE TIME FEASIBILITY OF A CLINICAL PATHWAY, ENABLING WORKFLOW ADJUSTMENTS

(71) Applicant: KONINKLIJKE PHILIPS N.V., Eindhoven (NL)

(72) Inventors: Richard Vdovjak, Eindhoven (NL); Anca Ioana Daniela Bucur, Eindhoven (NL)

(21) Appl. No.: 14/388,009

(22) PCT Filed: Mar. 20, 2013
(86) PCT No.: PCT/IB2013/052190

§ 371 Date: Sep. 25, 2014

Related U.S. Application Data
(60) Provisional application No. 61/617,235, filed on Mar. 29, 2012.

(51) Int. Cl. G06F 19/00; G06N 99/00

(52) U.S. Cl. CPC G06F 19/327; G06N 99/005
USPC 705/2

(57) ABSTRACT

When scheduling a clinical procedure such as a surgery, a clinician enters a deadline (i.e., a date of surgery or other procedure) and desired clinical procedures to be performed in advance thereof (e.g., lab tests, pathology tests, medical record review, etc.). A feasibility algorithm is executed and analyzes median pathway step completion times for a clinical pathway or workflow that is executed to satisfy the clinician's work order. A probability of completion of the clinical pathway by the specified deadline is also provided to the clinician. If the probability of completion is low (e.g., if the requested test results are unlikely to be ready by the scheduled surgery), then the clinician is prompted to adjust one or more of the surgery date and the clinical pathway steps to be completed thereby.

The present application finds particular application in clinical decision support systems. However, it will be appreciated that the described technique may also find application in other diagnostic systems, other medical scenarios, or other clinical techniques.

Conventional modern healthcare delivery often comprises a complicated workflow with many steps involving other sub-workflows, which include many inter-dependencies. Optimizing clinical workflow processes is an important means of both lowering healthcare costs and improving the quality of care.

Consider the following scenario from the oncology domain: A patient previously diagnosed with breast cancer has undergone neo-adjuvant chemotherapy. After eight weeks, the images taken for response assessment and for preoperative planning confirm the shrinkage of the known tumor, but the radiologist also notices a small mass formed in the upper quadrant of the breast, which has not been detected previously; however it may impact the planned treatment considerably. Normally, the patient would be scheduled to undergo a lumpectomy (a breast-conserving removal of the tumor) within a few days of the confirmed tumor shrinkage. However, the newly discovered suspicious mass is not close enough to the original tumor to be able to have it removed in one surgical incision. If malignant, either two incisions would be needed (which makes it much harder to perform a good breast conserving surgery), or a complete (or partial) mastectomy (a removal of the whole (or part of) breast) is needed. In either case, a completely new surgery plan becomes necessary. Finding a new malignant tumor may also change the response assessment of the neo-adjuvant treatment and determine changes in the adjuvant treatment plan.

In such a scenario, the treating physician needs to decide on the next steps; this will include discussions with his colleagues and the patient herself. However, one important question that needs to be answered before any decisions are made is whether the new mass is malignant or benign. The treating physician in this case would likely order an image guided biopsy to detect the nature of the new mass. This procedure involves several steps and spans several departments in the hospital. First, the treating physician (or the nurse) makes an appointment for the patient at the radiology department to extract the biopsy. The ultrasound guided breast biopsy is performed by a breast radiologist who specializes in interventional imaging. The specimen needs to be labeled and physically transported to the pathology lab/department, where several additional steps take place. The specimen is sliced and hybridized. A special staining agent is applied to the sample, the prepared sample is fixed on a slide which enters the scanning queue (for the example of Digital Pathology), and the sample is scanned and the resulting image is stored in a pathology picture archiving and communication system (Pathology PACS). The image enters a processing queue where an algorithm pre-processes the scanned image and, depending on the type of test (e.g., staining, etc.), the digital processing can involve several rounds. Next, the image and when applicable additional analysis results wait in the “interpretation” queue of the pathologist for interpretation. The image is finally interpreted by the pathologist and a PA report is written. At last, the treating clinician is notified of the result.

As the example above illustrates, a relatively simple diagnostic procedure can involve a complex sequence of workflow steps. Classical approaches do not enable the ordering physician to reliably evaluate the duration of the individual steps and the overall time it will take for the order to complete. In the scenario described above, the result of the biopsy is a key element in the decision making, but the time aspect plays a crucial role too. If the result of the biopsy is not back in time before the surgery, the clinician has only sub-optimal choices: i.e. a) proceed with the planned surgery irrespective of the new mass risking that there is still another cancerous lump left in the breast; b) Decide on possibly unnecessary extra surgery (e.g. partial mastectomy) with permanent consequences; c) cancel the surgery in the very last moment if the results of the biopsy do not come back in time. While the last option would probably be the best of the three for the patient given the lack of biopsy results (as the physician needs the biopsy results to make an optimal decision), keeping the expensive surgery team scheduled for the surgery that may or may not take place and cancelling it at the very last moment is certainly not cost effective.

The present application relates to new and improved systems and methods that facilitate determining clinical pathway feasibility and providing feasibility information to a clinician to further facilitate making optimal clinical decisions, which overcome the above-referenced problems and others.

In accordance with one aspect, a system that facilitates providing a user with an estimated probability of completion of a clinical pathway by a user-specified deadline includes a user interface via which the user enters a clinical order and specifies a deadline, and a processor configured to execute computer-executable instructions stored in a memory, the instructions comprising receiving the clinical order and deadline information, identifying and storing relevant steps and substeps of at least one pathway for satisfying the clinical order, and filtering and parsing information retrieved from an inter-department information hub to identify duration values for each step and substep in the at least one pathway. The instructions further comprise storing the identified duration values and actual completion time values for the steps and substeps in the at least one pathway, training a feasibility estimation algorithm using the identified duration values and the actual completion time values, and outputting via the user interface an estimated completion time for the at least one pathway and a probability of pathway completion by the specified deadline.

In accordance with another aspect, a method of providing a user with an estimated probability of completion of a clinical pathway by a user-specified deadline comprises receiving the clinical order and deadline information, identifying and storing relevant steps and substeps of at least one pathway for satisfying the clinical order, and filtering and parsing information retrieved from an inter-department information hub to identify duration values for each step and substep in the at least one pathway. The method further comprises storing the identified duration values and actual completion time values for the steps and substeps in the at least one pathway, training a feasibility estimation algorithm using the identified duration values and the actual completion time values, and outputting via the user interface an estimated completion time for the at least one pathway and a probability of pathway completion by the specified deadline.

According to another aspect, a method of providing a user with an estimated probability of completion of a clinical pathway by a user-specified deadline comprises receiving a clinical order and a deadline by which the order is to be fulfilled, determining a probability of completion of a clinical pathway for fulfilling the order by the deadline, determining that one or more steps in the clinical pathway cannot be completed by the deadline, and prompting the user to adjust at least one of the clinical pathway and the deadline.

Still further advantages of the subject innovation will be appreciated by those of ordinary skill in the art upon reading and understanding the following detailed description.

The innovation may take form in various components and arrangements of components, and in various steps and arrangements of steps. The drawings are only for purposes of illustrating various aspects and are not to be construed as limiting the invention.

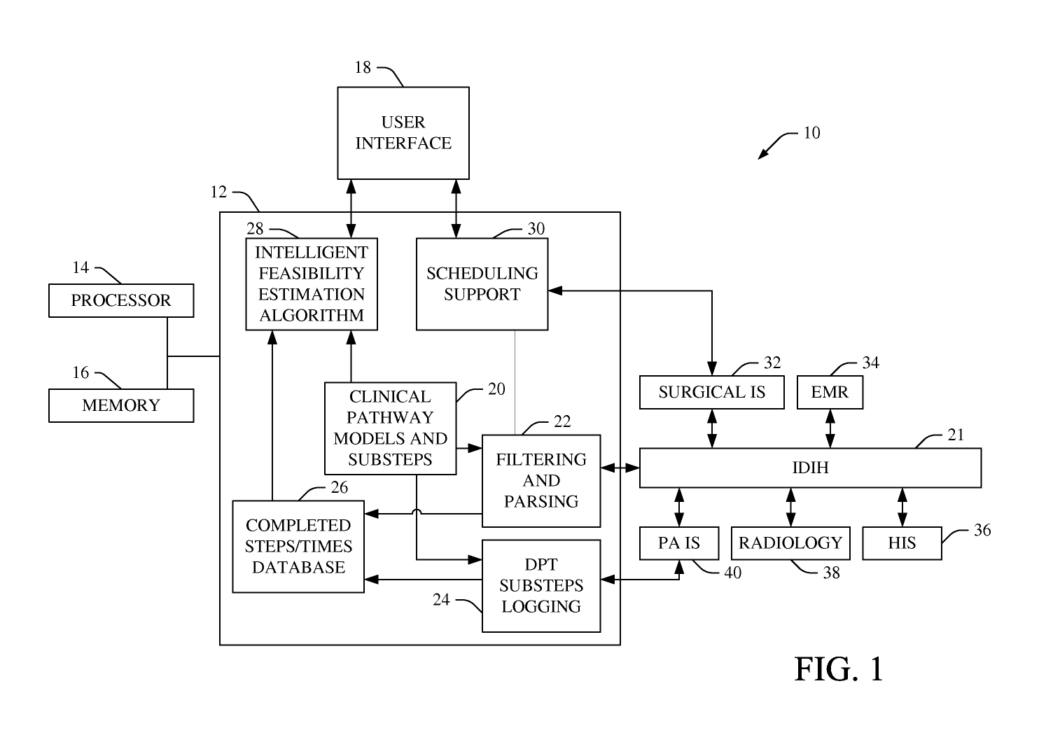

FIG. 1 illustrates a system that facilitates employing a collection of clinical pathway models, i.e. detailed description of all procedures, and in particular including all procedural sub-steps across and within the different departments in a healthcare organization.

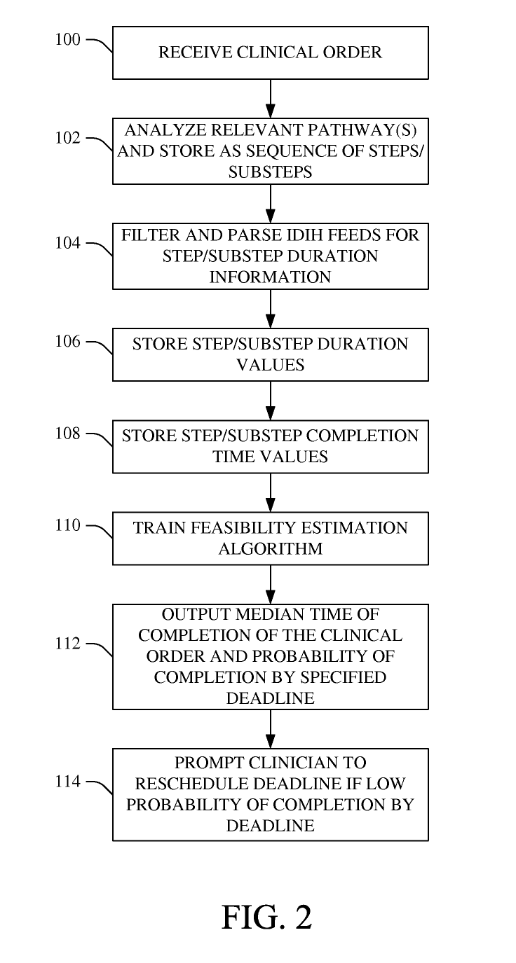

FIG. 2 illustrates a method of employing a collection of clinical pathway models including all procedural sub-steps across and within the different departments in a healthcare organization.

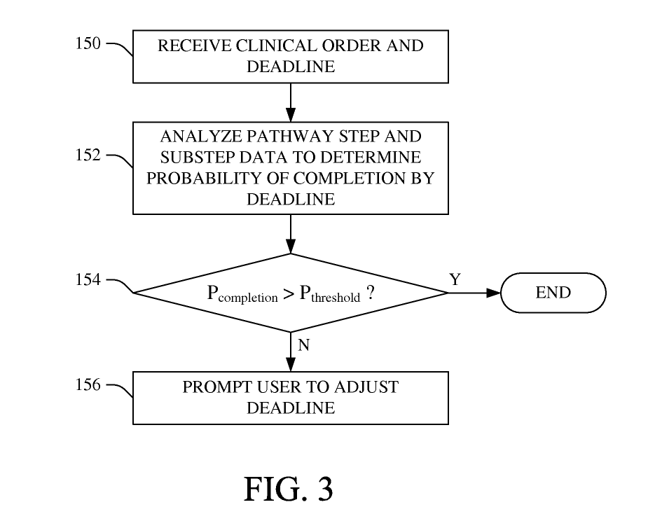

FIG. 3 illustrates a method of providing a clinician with a probability of clinical pathway completion by a user-specified deadline in accordance with various aspects described herein.

The subject innovation overcomes the aforementioned problems by precisely evaluating the time of delivering the requested results, or in other words checking the feasibility of a clinical pathway with regard to a deadline (e.g. the upcoming surgery) while taking into account the imposed duration of the steps involved, thereby greatly improving the decision making process and allowing for workflow optimization that in turn yields better patient outcomes and substantial cost savings. The described systems and methods also facilitate intra-departmental pathways improvement. For example, the pathology department in a hospital is a service provider to many other departments in the hospital. Due to the complexity and lengthy duration of pathology pathways, which combine many complex steps, pathologists benefit from the described systems and methods, which facilitate evaluating and increasing the efficiency of pathology department processes.

FIG. 1 illustrates a system 10 that facilitates employing a collection of clinical pathway models, i.e. detailed description of all procedures, and in particular including all procedural sub-steps across and within the different departments in a healthcare organization. The system creates a record for every procedure ordered and logs the time needed for each sub-step. This is achieved by connecting such system 10 to an inter-department information hub (IDHD) (e.g., Health Level 7 or “HL7” feeds) in the hospital environment, and intercepting and evaluating the relevant order and delivery messages. The system 10 provides time indications for the workflow steps across the departments at a coarse level. If more precise evaluation is desired, the system records the sub-steps within the involved departments, e.g. the pathology workflow can be analyzed in more detail thereby offering better estimation on the duration (taking into account the type of available staining procedures, type of required analyses, etc.).

For a new order, the system 10 indicates the average and the median time of completion of that particular order type based on previous records and presents the clinician with a probability value (including confidence intervals) that gives an estimate of delivering the order in time for an indicated deadline taking into account the deviations in the collected records. Based on this information and on the likelihood thresholds set, the system supports the further decision of the clinician. For instance the system 10 evokes a scheduling tool that allows rescheduling of a subsequent treatment step (in one scenario, the surgery), if the order is not likely to come back in time. In one embodiment, the scheduling tool includes a calendar that is presented to the clinician via a user interface, and the clinician is permitted to reschedule the scheduled treatment or surgery, adjust the pathway, etc., on a patient-by-patient basis.

The main elements of the system include a feasibility estimation module 12 that is coupled to a processor 14 that executes, and a memory 16 that stores, computer-executable instructions (e.g., code, routines, subroutines, algorithms, programs, applications, etc.) for performing the various functions, methods, techniques, etc., described herein. The processor and memory may be integral to the feasibility estimation module 12, a user interface 18 coupled thereto, or part of a separate computer or the like coupled to the feasibility estimation module 12 and/or the user interface 18. In one embodiment, the feasibility estimation module is stored in the memory 16, and executed by the processor 14.

The first phase in building the system involves observing and defining in sufficient detail all the relevant clinical pathways in the organization as a sequence of steps (actions of different departments as registered in IDIH feeds) and their sub-steps (actions within a single department). Thus, the feasibility estimation module includes clinical pathway models 20, including pathway substeps. Pathways that are frequently reused are additionally modeled and formalized. In one embodiment, a generic set of clinical pathways 20 is defined, and optionally abstracted. In this case, for each new organization in which the system 10 is deployed, generic workflows are detailed and analyzed to define the local instantiated workflows of the organization.

After all relevant pathways have been defined, filter and parse the IDIH 21 feeds of the hospital are filtered and parsed by a filtering and parsing module 22 (e.g., executed by the processor 14) to collect duration information for the different steps. At the level of each department, the durations of the sub-steps are logged and stored by a department substep logging module 24. In one embodiment, all substep time duration values are stored. In another embedment, an average of substep durations is computed and stored. In yet another embodiment, a median duration value is computed and stored, and the likelihood of meeting the deadline is calculated along with deviation and outlier values. All the data (completed steps and sub-steps and their durations, together with relevant statistics) is stored in a completed steps/times database 26, which is used for training a feasibility estimation algorithm 28 for feasibility estimation.

The active estimation of pathways is facilitated by taking as input a new request from a user (e.g., via the user interface 18) together with a deadline of that request, and translating that information into a corresponding pathway in the database. Then, based on the database of clinical pathways 20 the algorithm 28 computes the prediction of the actual duration of the pathway and the likelihood of meeting the deadline. This information is provided back to the requester via the user interface 18. When the likelihood of meeting the deadline is low, the ordering clinician may need to take corrective steps, such as rescheduling the surgery appointment for example. For this, a scheduling support module 30 is provided that coordinates scheduling of various components, services, facilities, procedures, clinicians, etc.

In one embodiment, the scheduling support module presents a calendar to the clinician and permits the clinician to reschedule the surgery or treatment deadline and/or to adjust the pathway on a patient-by-patient basis. Additionally, the calendar can be color coded such that a first color (e.g., green) is used to indicated that the selected pathway has a high probability (e.g., greater than approximately 90% or some other predetermined high probability threshold) of being completed before the indicated deadline and a second color (e.g., red) is used to indicate that the selected pathway has a low probability (e.g., less than approximately 40% or some other predetermined low probability threshold) of being completed before the indicated deadline. One or more additional colors can be employed to indicate varied degrees of completion probability above, below, and/or between the high and low probability thresholds. For instance, a dark green color can be used to indicate a 100% completion probability, medium green for 90%, light green for 80%, various shades of greenish-yellow, yellow, and orange for 70%, 60%, and 50% respectively, red for 40%, and so on. It will be appreciated that any desired level of granularity may be employed with regard to the foregoing features, and that the described systems and methods are not limited increments of 10%.

It will be appreciated that the IDIH 21 receives information from a plurality of sources or feeds, including a surgical information system (IS) 32, an electronic medical records (EMR) database 34, a hospital information system (HIS) 36, a radiology information system (RIS) 38, a pathology (PA) information system (IS) 40, or any other suitable medical database, information system, department or laboratory, or other information source. Additionally, the feasibility estimation algorithm is periodically or continuously updated and trained, so that if one of the departments (e.g., radiology, pathology, etc.) gets backlogged, a data window (e.g., one month, 3 months, one year, etc.) that is used to train the estimation algorithm can be enlarged. For instance, if the normal data window used to calculate pathway step completion times for the radiology department comprises 6 months of data and the radiology department gets backlogged in June, then the step completion time median and average values for January through June may skewed. In order to account for this phenomenon, the data window used to train the estimation algorithm can be enlarged (e.g., to 12 months or the like), in order to smooth out the effect of the backlog anomaly.

As stated above, the system 10 includes the processor 14 that executes, and the memory 16 that stores, computer-executable instructions (e.g., routines, programs, algorithms, software code, etc.) for performing the various functions, methods, procedures, etc., described herein. Additionally, “module,” as used herein, denotes a set of computer-executable instructions, software code, program, routine, or other computer-executable means for performing the described function, or the like, as will be understood by those of skill in the art.

The memory may be a computer-readable medium on which a control program is stored, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor can read and execute. In this context, the systems described herein may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like.

FIG. 2 illustrates a method of employing a collection of clinical pathway models including all procedural sub-steps across and within the different departments in a healthcare organization. The method creates a record for every procedure ordered and logs the time needed for each sub-step. This is achieved by providing time indications for the workflow steps across the departments at a coarse level. If more precise evaluation is desired, the method records the sub-steps within the involved departments, e.g. the pathology workflow can be analyzed in more detail thereby offering better estimation on the duration (taking into account the type of available staining procedures, type of required analyses, etc.).

At 100, a new clinical order is received (e.g., via a user interface) along with deadline information (e.g., a date and/or time of a scheduled surgery or other treatment). At 102, relevant clinical pathways in the healthcare organization are analyzed and stored as a sequence of steps (e.g., clinical actions of different departments involved in each pathway as registered or otherwise indicated in IDIH feeds) and their sub-steps (actions within a single department). Pathways that are frequently reused are additionally modeled and formalized. In one embodiment, a generic set of clinical pathways is defined, and optionally abstracted. In this case, for each new healthcare organization in which the method is employed, generic workflows are detailed and analyzed to define the local instantiated workflows of the organization.

After all relevant pathways have been defined and stored, IDIH feeds of the hospital are filtered and parsed, at 104, to collect duration information for the different pathway substeps. It will be appreciated that the IDIH receives information from a plurality of sources or feeds, including a surgical information system (IS), an electronic medical records (EMR) database, a hospital database, a radiology database, a pathology (PA) information system (IS), or any other suitable medical database, information system, department, or other information source. At the departmental level, the durations of the substeps are logged and stored. In one embodiment, all substep time duration values are stored, at 106. In another embedment, an average of substep durations is computed and stored for each substep. In yet another embodiment, a median duration value for each substep is computed and stored, and the likelihood of meeting the deadline is calculated along with deviation and outlier values. All the data (completed steps and sub-steps and their durations, together with relevant statistics) is stored in a completed steps/times database at 108. At 110, a feasibility estimation algorithm is trained using the completed step duration information.

At 112, the average time and the median time of completion of that particular order type based on previous records is retrieved and presented to the clinician with a probability value (including confidence intervals) that gives an estimate of delivering the order in time for an indicated deadline taking into account the deviations in the collected records. When the likelihood of meeting the deadline is low, the ordering clinician may need to take corrective steps, such as rescheduling the surgery appointment for example. For this, a scheduling support interface that coordinates scheduling of various components, services, facilities, procedures, clinicians, etc., is presented to the user at 114.

The described systems and methods can be used in the healthcare industry to support workflow optimization and increased efficiency. It also facilitates, at the hospital level, improving patient service by reducing the time until a next appointment or next procedure, and by providing a more reliable estimation of when test results will be available than can be provided by conventional approaches. Currently, in addition to high workload, a prominent reason that clinicians schedule longer waiting times until an appointment or procedure is that clinicians want to make sure that the results of patient tests will be available in time for the appointment or procedure, before the patient shows up for the appointment. This results in waiting times in the order of weeks, which for potential cancer patients can be a huge source of anxiety.

FIG. 3 illustrates a method of providing a clinician with a probability of clinical pathway completion by a user-specified deadline in accordance with various aspects described herein. At 150, the user (i.e., the clinician) specifies a deadline (e.g., a date of surgery or other treatment) by which the user would like to receive test result data. At 152, pathway step and substep data (e.g., logged substep data, completed step/time information, pathway model information, etc.) for the patient is analyzed by a feasibility estimation algorithm, which outputs a probability that the patient's results will be available by the deadline. At 154, a determination is made regarding whether the probability that patient's results will be available by the deadline is above a predetermined threshold level. If the probability that the patient's test results will be available by the deadline is equal to or greater than a predetermined threshold level, then the method ends. If the probability that the patient's test results will be available by the deadline is less than the predetermined threshold level, then at 156, the user is prompted to reschedule the treatment associated with the deadline, at the user's discretion.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

1. A system that facilitates providing a user with an estimated probability of completion of a clinical pathway by a user-specified deadline, including:
a user interface via which the user enters a clinical order and specifies a deadline; and
a processor configured to execute computer-executable instructions stored in a memory, the instructions comprising:
receiving the clinical order and deadline information;
identifying and storing relevant steps and substeps of at least one pathway for satisfying the clinical order;
filtering and parsing information retrieved from an inter-department information hub to identify duration values for each step and substep in the at least one pathway;
storing the identified duration values and actual completion time values for the steps and substeps in the at least one pathway;
training a feasibility estimation algorithm using the identified duration values and the actual completion time values; and
outputting via the user interface an estimated completion time for the at least one pathway and a probability of pathway completion by the specified deadline.

2. The system according to claim 1, the instructions further comprising presenting to the user via the user interface a scheduling tool comprising a calendar that shows the specified deadline and estimated completion times of one or more steps and substeps in the pathway.

3. The system according to claim 2, the instructions further comprising color-coding the calendar, wherein a first color is used to indicated that the at least one pathway has a completion probability greater than a predetermined high probability threshold and a second color is used to indicate that the selected pathway has a completion probability less than a predetermined low probability threshold, which is lower than the predetermined high probability threshold.

4. The system according to claim 1, the instructions further comprising:
prompting the user to adjust at least one of:
the deadline; and
at least one of a pathway step and a pathway substep;
in order to increase the probability of pathway completion by the specified deadline

5. The system according to claim 1, the instructions further comprising:
periodically re-training the feasibility estimation algorithm using a predefined time window of identified duration values and actual completion time values.

6. The system according to claim 5, the instructions further comprising:
increasing the predefined time window upon a determination that one of more departments performing a step or substep in the at least one pathway has become backlogged.

7. The system according to claim 1, wherein the deadline is a scheduled time of at least one of a surgery and a medical treatment.

8. The system according to claim 1, wherein the information retrieved from an inter-department information hub comprises data from at least one of:
a pathology department information system;
a laboratory information system;
electronic medical record system;
a surgical department information system; and
a radiology department information system.

9. The system according to claim 1, wherein the clinical order comprises a request for performance of one or more clinical procedures on a patient.

10. A method of providing a user with an estimated probability of completion of a clinical pathway by a user-specified deadline, comprising:
receiving the clinical order and deadline information;
identifying and storing relevant steps and substeps of at least one pathway for satisfying the clinical order;
filtering and parsing information retrieved from an inter-department information hub to identify duration values for each step and substep in the at least one pathway;
storing the identified duration values and actual completion time values for the steps and substeps in the at least one pathway;
training a feasibility estimation algorithm using the identified duration values and the actual completion time values; and
outputting via the user interface an estimated completion time for the at least one pathway and a probability of pathway completion by the specified deadline.

11. The method according to claim 10, further comprising presenting to the user via the user interface a scheduling tool comprising a calendar that shows the specified deadline and estimated completion times of one or more steps and substeps in the pathway.

12. The method according to claim 11, further comprising color-coding the calendar, wherein a first color is used to indicated that the at least one pathway has a completion probability greater than a predetermined high probability threshold and a second color is used to indicate that the selected pathway has a completion probability less than a predetermined low probability threshold, which is lower than the predetermined high probability threshold.

13. The method according to claim further comprising:
prompting the user to adjust at least one of:
the deadline; and
at least one of a pathway step and a pathway substep;
in order to increase the probability of pathway completion by the specified deadline

14. The method according to claim 10, further comprising:
periodically re-training the feasibility estimation algorithm using a predefined time window of identified duration values and actual completion time values.

15. The method according to claim 14, further comprising:
increasing the predefined time window upon a determination that one of more departments performing a step or substep in the at least one pathway has become backlogged.

16. The method according to claim 10, wherein the deadline is a scheduled time of at least one of a medical treatment or procedure (e.g. surgery).

17. The method according to claim 10, wherein the information retrieved from an inter-department information hub comprises data from at least one of:
a pathology department information system;
a laboratory information system;
electronic medical record system;
a surgical department information system; and
a radiology department information system.

18. The method according to claim 10, wherein the clinical order comprises a request for performance of one or more clinical procedures on a patient.

19. A processor or computer-readable medium carrying a computer program that controls one or more processors to perform the method of claim 10.

20. A method of providing a user with an estimated probability of completion of a clinical pathway by a user-specified deadline, comprising:
receiving a clinical order and a deadline by which the order is to be fulfilled;
determining a probability of completion of a clinical pathway for fulfilling the order by the deadline;
determining that one or more steps in the clinical pathway cannot be completed by the deadline; and
prompting the user to adjust at least one of the clinical pathway and the deadline.
